(19) United States
(12) Patent Application Publication
(10) Pub. No.: US 2024/0390803 A1
(43) Pub. Date: Nov. 28, 2024

(54) METHOD, COMPUTER DEVICE, AND NON-TRANSITORY COMPUTER-READABLE RECORDING MEDIUM TO PROVIDE BOT-BASED ROLE-PLAYING SERVICE ON SOCIAL PLATFORM

(71) Applicant: LINE Plus Corporation, Seongnam-SI (KR)

(72) Inventors: Soon Hyun KWON, Seongnam-si (KR); Chaewon JUNG, Seongnam-si (KR); Daeun JUNG, Seongnam-si (KR); Seo Hyun CHO, Seongnam-si (KR); SeonYoung KANG, Seongnam-si (KR); EuGene KO, Seongnam-si (KR); Dae Eun YOON, Seongnam-si (KR)

(73) Assignee: LINE Plus Corporation, Seongnam-SI (KR)

(21) Appl. No.: 18/670,887

(22) Filed: May 22, 2024

(30) Foreign Application Priority Data
May 22, 2023 (KR) 10-2023-0065558

(51) Int. Cl. A63F 13/822; A63F 13/63; A63F 13/87; G06F 40/40

(52) U.S. Cl. CPC A63F 13/822; A63F 13/63; G06F 40/40; A63F 13/87

(57) ABSTRACT

A bot-based role-playing method performed by a computer device comprising at least one processor configured to execute computer-readable instructions in a memory, includes: receiving, by the at least one processor, a script for an openchat; and creating, by the at least one processor, at least one character bot for role-playing in the openchat by learning at least one character included in the script through an artificial intelligence (AI) language model.

### CROSS-REFERENCE TO RELATED APPLICATION

This application is based on and claims priority under 35 U.S.C. § 119 to Korean Patent Application No. 10-2023-0065558, filed May 22, 2023 in the Korean Intellectual Property Office (KIPO), the disclosure of which is incorporated herein by reference in its entirety.

### BACKGROUND

### 1. Field

The disclosure relates to a technology for providing a role-playing game.

### 2. Description of Related Art

An instant messenger is a general communication tool and is software that allows a user to send and receive a message or data in real time with other users. The user may register a contact person on a contact list of a messenger and may send and receive messages with the contact person on the contact list in real time.

A messenger is commonly used in a mobile environment of a mobile communication terminal as well as a personal computer (PC). For example, a mobile messenger service system and a method of the mobile communication terminal using a wireless communication network provide a messenger service between mobile messengers installed on portable terminals.

As the use of the messenger becomes more popular and functions provided through the messenger become more diversified, an openchat service (function), which enables a chat using a link without sharing personal information (such as a telephone number and an ID) has been provided to the users.

### SUMMARY

Provided is to create a character bot for role-playing on a social platform using an artificial intelligence (AI) model.

Provided is to push various role-playing situations based on learning content of a corresponding bot and actual offline information through a character bot.

Provided is to determine role-playing fitness of a user that plays a role of a corresponding character according to persona of a character bot.

Provided is to create secondary content from a series of conversations created by a user taking on a role of a specific character bot and another character bot.

According to an aspect of the disclosure, a bot-based role-playing method performed by a computer device comprising at least one processor configured to execute computer-readable instructions in a memory, includes: receiving, by the at least one processor, a script for an openchat; and creating, by the at least one processor, at least one character bot for role-playing in the openchat by learning at least one character included in the script through an artificial intelligence (AI) language model.

According to an aspect of the disclosure, a computer device includes: at least one processor configured to execute non-transitory computer-readable instructions included in a memory, wherein the at least one processor is configured to process an operation of creating at least one character bot for role-playing in an openchat by learning at least one character included in a script through an artificial intelligence (AI) language model

### BRIEF DESCRIPTION OF DRAWINGS

The above and/or other aspects will be more apparent by describing certain example embodiments, with reference to the accompanying drawings, in which:

FIG. 1 illustrates an example of a network environment according to at least one example embodiment;

FIG. 2 illustrates a configuration of a computer device according to at least one example embodiment;

FIG. 3 illustrates an example of a method performed by a computer device according to at least one example embodiment;

FIG. 4 illustrates an example of describing a process of creating a character bot for role-playing according to at least one example embodiment;

FIG. 5 illustrates an example of describing a role-playing conversation between a character bot and a user according to at least one example embodiment;

FIGS. 6 and 7 illustrate examples of setting a processing process based on role-playing fitness of a user according to at least one example embodiment;

FIGS. 8 and 9 illustrate examples of describing a process of creating secondary content of openchat according to at least one example embodiment; and

FIG. 10 illustrates an example of describing a process of sharing secondary content of openchat according to at least one example embodiment.

These drawings are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be translated as defining or limiting the range of values or properties encompassed by example embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein translated accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be translated as having a meaning that is consistent with their meaning in the context of the relevant art and/or this disclosure, and should not be translated in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), a CPU, a controller, an ALU, a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to forward and/or distribute the computer programs, program code, instructions, or some combination thereof, over a network. The remote computing system may forward and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to a technology for providing a role-playing game on a social platform. The example embodiments including the disclosures set forth herein may quickly create a role-playing bot on a social platform using an artificial intelligence (AI) model and may use the role-playing bot for various purposes, such as determining role-playing fitness, creating a role-playing situation, and creating secondary content, on the social platform.

A bot-based role-playing system according to some example embodiments may be implemented by at least one computer device and a bot-based role-playing method according to some example embodiments may be performed by at least one computer device included in the bot-based role-playing system. Here, a computer program according to an example embodiment may be installed and executed on the computer device and the computer device may perform the bot-based role-playing method according to example embodiments under control of the executed computer program. The aforementioned computer program may be stored in a computer-readable recording medium to computer-implement the bot-based role-playing method in conjunction with the computer device.

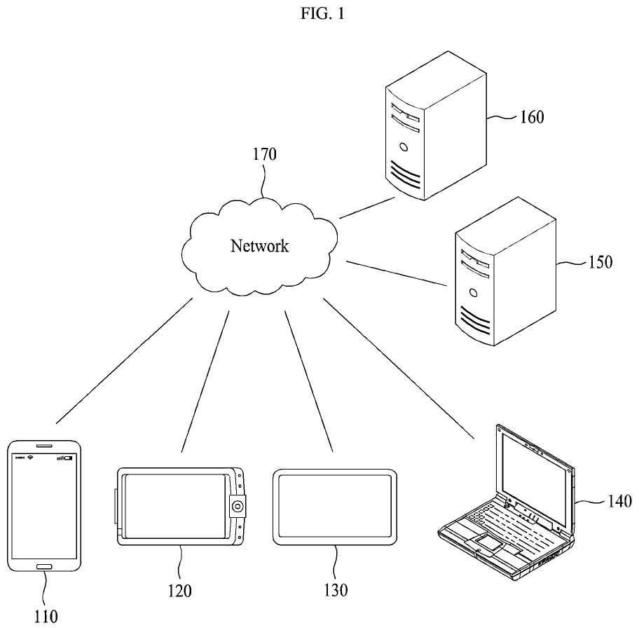

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. The number of electronic devices or the number of servers is not limited thereto. Also, the network environment of FIG. 1 is provided as one example of environments applicable to the example embodiments and an environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, and a broadcasting network) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service (e.g., a role-playing service) to the plurality of electronic devices 110, 120, 130, and 140 connected over the network 170.

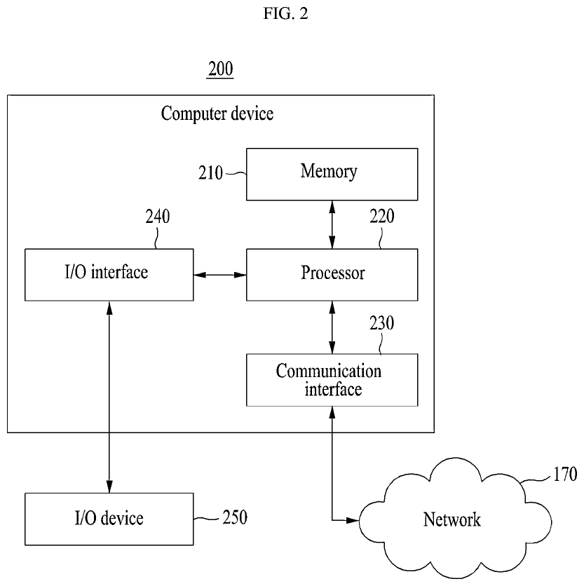

FIG. 2 illustrates an example of a computer device according to at least one example embodiment. Each of the plurality of electronic devices 110, 120, 130, and 140 or each of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable recording medium. The permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable recording medium separate from the memory 210. The other non-transitory computer-readable recording medium may include a non-transitory computer-readable recording medium, for example, a floppy drive, a disk, a tape, a DVD/CD-ROM drive, a memory card, etc. According to other example embodiments, software components may be loaded to the memory 210 through the communication interface 230, instead of the non-transitory computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided by the memory 210 or the communication interface 230 to the processor 220. For example, the processor 220 may be configured to execute received instructions in response to a program code stored in a storage device, such as the memory 210. The processor 220 may refer to or correspond to one or more processors (at least one processor). The processor 220 may include or correspond to circuitry like a CPU, a microprocessor unit (MPU), an application processor (AP), a coprocessor (CP), a system-on-chip (SoC), or an integrated circuit (IC).

The communication interface 230 may provide a function for communication between the computer device 200 and another apparatus, for example, the aforementioned storage devices, through the network 170. For example, the processor 220 of the computer device 200 may deliver a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200 over the network 170. For example, a signal, an instruction, data, etc., received through the communication interface 230 may be delivered to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with a device in which an input function and an output function are integrated into a single function, such as a touchscreen. The I/O device 250 may be configured as a single device with the computer device 200.

Also, according to other example embodiments, the computer device 200 may include a greater or smaller number of components than the number of components of FIG. 2. However, there is no need to clearly illustrate many conventional components. For example, the computer device 200 may be configured to include at least a portion of the I/O device 250 or may further include other components, such as a transceiver and a database.

Hereinafter, specific example embodiments of a method and apparatus for providing a bot-based role-playing service on a social platform are described.

Herein, the social platform may represent a service platform that provides a social network service (such as a messenger and various types of communities) and various types of services using resources (such as user profile information and friend relation within the social network service).

The following example embodiment is described using a ‘messenger’ as a representative example of the social platform. The example embodiment may provide a role-playing game using a chatbot through openchat.

In some embodiments, openchat refers to a chat service that allows users to have conversations over a topic of interest and also refers to a ‘community service’ that allows direct chatting through a link such as a uniform resource locator (URL), without a friend addition process using a telephone number or an identification (ID). An openchat link may include a function that automatically launches a messenger and runs a chatroom of a corresponding link to allow an immediate chat in response to clicking the link.

The computer device 200 according to the example embodiment may provide a client with a role-playing service through a connection to a dedicated application installed on the client or a website/mobile site related to the computer device 200. A computer-implemented bot-based role-playing system may be configured in the computer device 200. For example, the bot-based role-playing system may be implemented in an independently operating program form (software) or may be configured in an in-app form of a specific application to be operable on the specific application.

The processor 220 of the computer device 200 may be implemented as a component for performing the following bot-based role-playing method. Depending on example embodiments, the components of the processor 220 may be selectively included in or excluded from the processor 220. Also, depending on example embodiments, the components of the processor 220 may be separated or merged for functional representations of the processor 220.

The processor 220 and the components of the processor 220 may control the computer device 200 to perform operations included in the following bot-based role-playing method. For example, the processor 220 and the components of the processor 220 may be implemented to execute an instruction according to a code of at least one program and a code of an OS included in the memory 210.

Here, the components of the processor 220 may be representations of different functions performed by the processor 220 according to an instruction provided from a program code stored in the computer device 200.

The processor 220 may read a necessary instruction from the memory 210 to which instructions related to control of the computer device 200 are loaded. In this case, the read instruction may include an instruction for controlling the processor 220 to perform the following operations.

Operations included in the following bot-based role-playing method may be performed in orders different from the illustrated order. Some of operations may be omitted, or an additional process may be further included.

Operations included in the bot-based role-playing method may be performed by the server 150 and, depending on example embodiments, at least some of the operations may also be performed by a client.

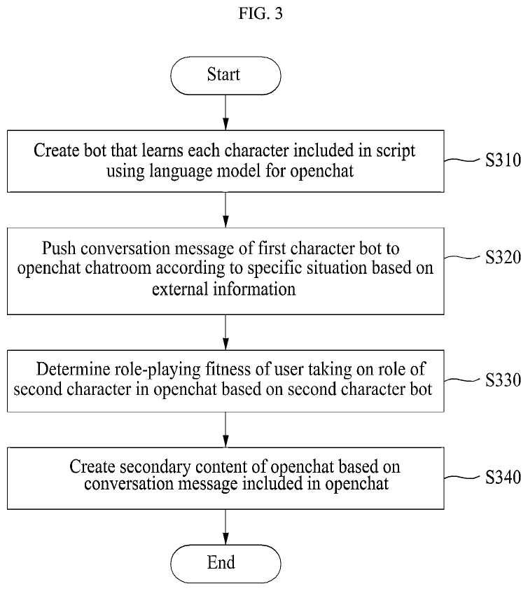

FIG. 3 illustrates an example of a method performed by a computer device according to at least one example embodiment.

Referring to FIG. 3, in operation S310, when a script is given from a corresponding openchat administrator (‘admin’) for openchat, the processor 220 may create a bot that learns each character included in the script using a language model. Here, the script may represent primary content that is a text corpus containing a line (or lines) of a plurality of characters, such as a play or a novel. The processor 220 may receive the script given by the administrator through a separate administrator channel in the openchat.

Depending on example embodiments, the processor 220 may also receive a script that is input with an administrator tag (e.g., bot #) for requesting a bot creation through a chatroom of the openchat. Here, the processor 220 may also receive a corresponding character's profile information (e.g., age, personality, nationality, introduction, etc.) and era information or region information that serves as the background of the script as additional information, along with the script.

The processor 220 may input the script to an artificial intelligence (AI) language model capable of understanding and creating natural language, such as a generative pretrained transformer (GPT) model, for example, specialized for conversations, may analyze and learn a line (or lines) of each character through the corresponding language model, and may create a chatbot (hereinafter, ‘character bot’) that reflects persona of each character.

The language model may learn a corresponding character, including a line (or lines) of the character through the script and interactions or situations in the script, and may perform learning that reflects profile information, era information, and region information given as additional information for each character or script. Therefore, the processor 220 may learn the script given by the administrator through the AI language model and may create a plurality of character bots for role-playing in openchat.

In operation S320, the processor 220 may create a specific situation based on external information in relation to a character bot (hereinafter, ‘first character bot’) that directly participates in a conversation of openchat and may push the same to an openchat chatroom as a conversation message of a first character. In the example embodiment, the processor 220 may provide a role-playing game in which a user participating in corresponding openchat takes on a role of at least one character bot among the plurality of character bots through the openchat. Here, some character bots among the plurality of character bots may also directly participate in the conversation.

In role-playing, a situation given to characters is also very important. A role-playing bot may learn a line (or lines) of a corresponding character and various situations in the script through the script that is the primary content. The processor 220 may create a conversation message of the first character by linking external information, such as real offline weather or season, location, time, and recent issues, to a learned situation of the first character bot. That is, the processor 220 may automatically suggest a specific situation created by linking the external information acquirable as real offline information to the learned situation of the first character bot, as a conversational topic of role-playing through the first character bot.

In operation S330, when any one user participating in the openchat takes on a role of a specific character bot (hereinafter, ‘second character bot’) among the plurality of character bots, and then, participates in the conversation of the corresponding openchat, the processor 220 may determine role-playing fitness of the user for a second character, based on the second character bot. The processor 220 may determine a degree at which imitation of the user (human) matches an actual character based on a character bot created through the AI language model. For example, the processor 220 may compare the user's answer content and the second character bot' answer content as a response to a conversation message of a counterpart (e.g., another character bot or another user taking on a role of the other character bot), that is, the given situation during the conversation and may determine the role-playing fitness of the user, based on the answer similarity.

As another example, the processor 220 may determine the role-playing fitness of the corresponding user, based on the score given by a role-playing master (e.g., openchat administrator) set in openchat for the user' answer.

As another example, the processor 220 may determine the role-playing fitness of the user by assigning a weight according to (or based on) the score of the role-playing master to the similarity of the user's answer compared to the second character bot' answer content. For example, although the user's answer is not similar to the second character bot's answer, the answer may have a high degree of understanding for the character depending on the master's judgement. In this case, the user's answer may be evaluated to have high fitness.

As another example, the processor 220 may determine the role-playing fitness of the user based on a matching status between the user's answer and additional information, such as profile information, era information, and region information provided to the second character bot. For example, if the user's answer contains foreign language expression based on era information in which second character appears in a historical drama set in the Chosun Dynasty or the American Civil War, a low fitness score may be given due to mismatch with the era information.

As another example, the processor 220 may proceed with voting on the answer of the user taking on the role of the second character with respect to other users that participate in openchat and may determine the role-playing fitness of the user for the second character, based on voting results.

The processor 220 may determine whether to cast (or select) the user for the second character based on the role-playing fitness of the user. For example, if the role-playing fitness of the user for the second character is less than a threshold, the processor 220 may withdraw the corresponding user from the role of the second character and may cast another user participating in the openchat as a role-playing participant for the second character.

In operation S340, the processor 220 may create secondary content of the corresponding openchat based on conversation messages of role-playing included in the openchat. The processor 220 may segment (or divide) a series of conversation (exchanged between a character bot) and users (casted as role-playing participants) into topic-based episode units and may use the same as the secondary content.

For example, the processor 220 may create, as the secondary content, conversation content of a section directly selected by the openchat administrator or a user having a predetermined right among users that participate in the openchat. As another example, the processor 220 may compare the conversation between the character bot and the user casted as a role-playing participant to the script that is the primary content and may create the secondary content based on similarity.

For example, the processor 220 may create conversation content of which similarity with the primary content is lower by a predetermined level or more, that is, conversation content of a section different from that of the primary content as the secondary content. As another example, the processor 220 may select a main message having high participation, popularity, or information from among messages included in the chatroom of openchat and may create the selected main message as the secondary content. Here, the processor 220 may select the main message using information derivable from the chatroom, for example, a number of concurrent participants and a number of messages, stay time (e.g., a time value acquired by subtracting a time of entering the chatroom from a time of leaving the chatroom), and a keyword included in a message.

As an example of selecting the main message, the processor 220 may compare messages included in the chatroom to the primary content and may select a message containing many significant words from among words absent in the primary content, as the main message. That is, the processor 220 may select a message containing new contents compared to the primary content, as the main message.

As another example, the processor 220 may select at least one message as the main message based on a point in time at which the number of users participating in (connected to) the chatroom in the same time zone is greater than or equal to a threshold, a point in time at which the number of messages rapidly increases to be greater than or equal to a threshold, or a point in time at which the average stay time of each user participating in the chatroom is greater than or equal to a threshold.

As another example, the processor 220 may select a message including a keyword preset by an openchat administrator as a message that is highly likely to be useful to users in terms of information. The administrator may preset at least one keyword of interest through settings for the openchat chatroom and the processor 220 may select, as the main message, a message including a specific keyword set by the administrator from among messages included in the chatroom. In addition to a keyword directly set by the openchat administrator, the processor 220 may select the main message using a keyword that matches a category of the chatroom.

As another example, the processor 220 may extract a topic with high topicality by analyzing a conversation pattern in the chatroom and may select a message that matches the corresponding topic as the main message. The processor 220 may extract at least one word that is talked about in the chatroom based on a unit time and may determine a word that exceeds a certain level as the topic with topicality using the probability distribution of topic for each message included in the chatroom. The processor 220 may select, as the main message, a message including a keyword identical or similar to each topic from among messages included in the chatroom.

As another example, the processor 220 may track a view time of users participating in the chatroom and may select, as the main message, a message in an area with a view greater by at least a certain ratio than the average.

As another example, the processor 220 may select the main message based on reactions of other users participating in the chatroom. For example, the processor 220 may select, as the main message, a message in which a positive reaction meets a determined condition, such as like, mention, reply, comment, share, capture, and keep from other users, from among messages included in the openchat chatroom.

The processor 220 may create the main message selected from the openchat chatroom as the secondary content sharable through corresponding openchat or various pages of other openchat (e.g., chatroom and main screen). For example, the processor 220 may convert the main message to image-typed content through a screen capturing of an area including the main message in the openchat chatroom.

As another example, the processor 220 may convert the main message to video-typed content through screen recording of an area including the main message in the chatroom. The secondary content in the form of video may be created in various types of content, such as graphics interchange format (GIF) in which main messages are sequentially displayed in temporal order using graphic technology, such as animation and effect, in addition to screen recording. The secondary content may be shared between users having not experienced role-playing in the openchat and this may arouse interest and may also encourage subscription to openchat and service activation.

Therefore, as particular applications of the disclosure, the processor 220 may more conveniently and quickly create a role-playing bot to use in openchat using the AI language model, and may use the role-playing bot created through the AI language model for various functions in the openchat.

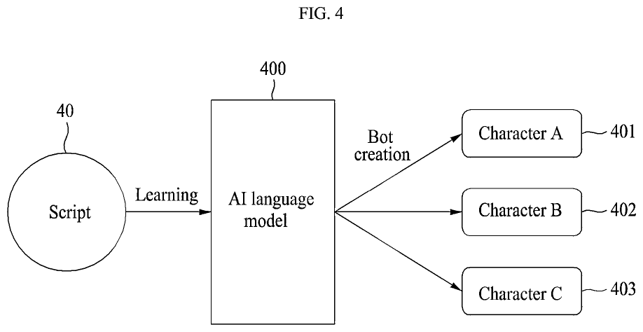

FIG. 4 illustrates an example of describing a process of creating a character bot for role-playing according to at least one example embodiment.

Referring to FIG. 4, the processor 220 may receive a script 40 given by an administrator through a separate administrator channel in the openchat and may input the same into an AI language model 400.

The script 40 may represent a text corpus containing a line (or lines) of a plurality of characters, such as a play or a novel, and a plurality of character bots 401, 402, and 403 may be created from the script 40. Depending on example embodiments, the script 40 created based on a line (or lines) of a corresponding character may be individually given for each character.

The AI language model 400 may create the character bot 401, 402, 403 that reflects persona of each character by analyzing and learning the line (or lines) of each character included in the script 40. Here, the AI language model 400 may perform learning including not only the line (or lines) of characters and interactions or situations in the script 40 and, also, may perform learning that reflects profile information of each character and era or region information given as additional information.

Therefore, the processor 220 may learn a conversation of each character through the script 40 given by the administrator through the AI language model 400 and may create the plurality of character bots 401, 402, and 403 for role-playing in openchat.

In the following descriptions of the disclosure, role-playing bots of Character A, Character B, and Character C are created for Openchat I.

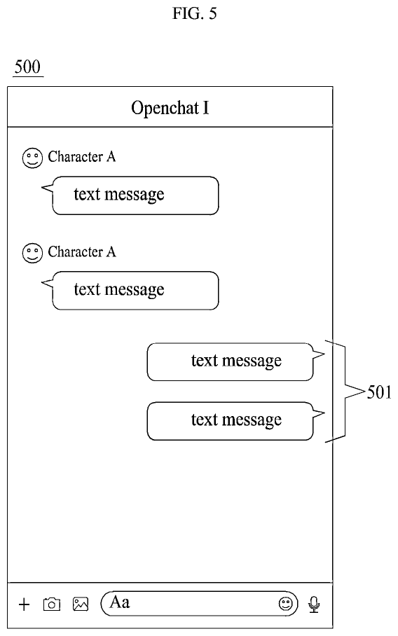

FIG. 5 illustrates an example of describing a role-playing conversation between a character bot and a user according to at least one example embodiment.

Openchat I may provide a role-playing game in which a user participating in Openchat I takes on a role of at least one character among ‘Character A,’ ‘Character B,’ and ‘Character C.’

FIG. 5 illustrates an Openchat I chatroom 500 displayed on an electronic device of User X who is cast in the role of Character B. In the Openchat I chatroom 500, User X may take on the role of Character B and may input conversation messages 501 acting as Character B.

In the Openchat I chatroom 500, a Character A bot may directly participate in conversation. Here, the Character A bot may create a conversation message for a role-playing situation by linking external information, such as actual offline weather or season, a location, and recent issues, to a learned situation. In an embodiment, information on the internet (such as weather or news related to the information defined in character A) is searched, and use the search results as external information needed to create a conversation message. In an embodiment, in the morning when showers are predicted according to weather forecast (e.g., acquired from the internet), the Character A bot may consider a learned situation and may push a specific situation based on external information, such as “This morning, I left home without an umbrella and arrived at the bus stop, and it rained suddenly” as a conversational topic. In an embodiment, when weather information that showers are predicted in the morning is acquired from an external source (e.g., the internet), the weather information is input to the AI language model 400, and the AI language model 400 may learn a given situation and may push a message based on the weather information for the Character A bot, such as “This morning, I left home without an umbrella and arrived at the bus stop, and it rained suddenly” as a conversational topic.

In the Openchat I chatroom 500, User X who takes on the role of Character B may continue the role-playing conversation, suggesting various situations with the Character A bot as a conversational topic.

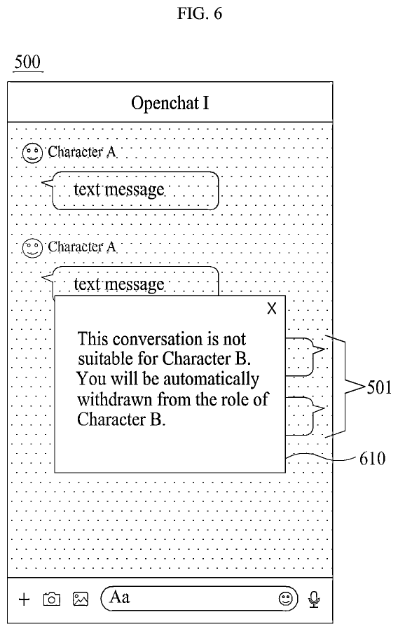

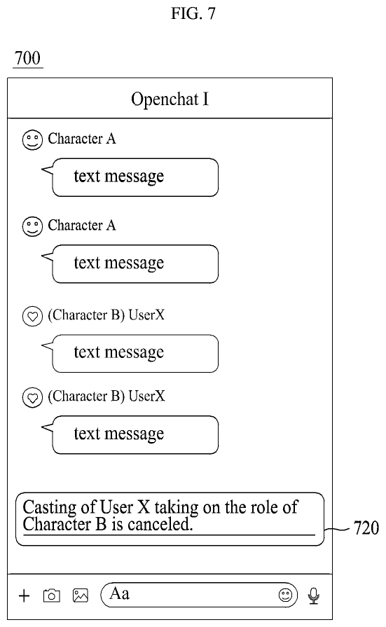

FIGS. 6 and 7 illustrate examples of setting a processing process based on role-playing fitness of a user according to at least one example embodiment.

The processor 220 may determine role-playing fitness of User X for Character B using the conversation messages 501 of User X who takes on the role of Character B. The processor 220 may acquire Character B's answer for a situation given as a conversation message of the Character A bot, may compare the Character B bot's answer to the conversation messages 501 input as User X's answer, and may determine the role-playing fitness of User X based on answer similarity.

Depending on example embodiments, the processor 220 may determine the role-playing fitness of User X based on evaluation results by a role-playing master (e.g., openchat administrator) set in Openchat I for the conversation messages 501 of user X who takes on the role of Character B, a matching status with profile information, era information, and region information given to Character B, and voting results by other users that participate in Openchat I.

When the role-playing fitness of User X taking on the role of Character B determined based on the conversation messages 501 is less than a threshold, the processor 220 may withdraw User X from the role of Character B and may allow the Character B bot to participate in Openchat I or may cast another user participating in Openchat I as a role-playing participant for Character B instead of User X.

When User X is withdrawn from the role of Character B, the processor 220 may provide a withdrawal notification 610 according to (or based on) role-playing unfitness to User X through the Openchat I chatroom 500 as shown in FIG. 6. Referring to FIG. 7, in an Openchat I chatroom 700 displayed on an electronic device of another user participating in Openchat I, a withdrawal notification 720 of User X, a previous role-playing participant for Character B, may be displayed. After withdrawal of User X, another user participating in Openchat I may request to participate in role-playing for Character B.

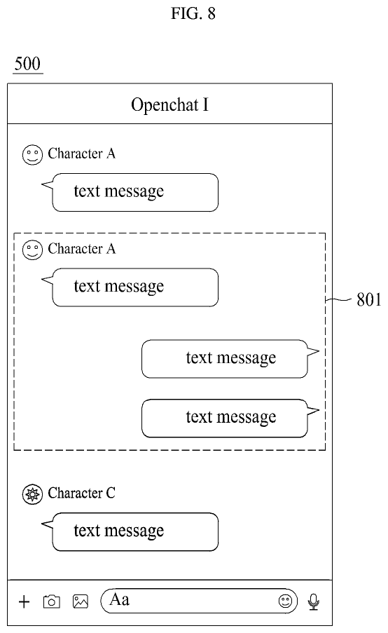

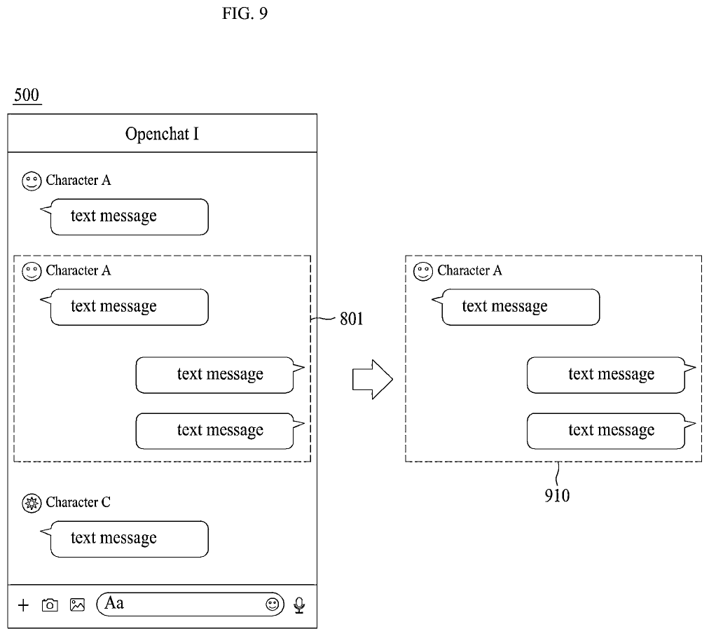

FIGS. 8 and 9 illustrate examples of describing a process of creating secondary content of openchat according to at least one example embodiment.

In the Openchat I chatroom 500, the Character A bot and the Character C bot may participate in role-playing conversation with User X taking on the role of Character B.

Referring to FIG. 8, the processor 220 may select a main message 801 with high participation, popularity, or information from among messages (i.e., conversation messages exchanged among the Character A bot, the Character C bot, and user X) included in the Openchat I chatroom 500. The processor 220 may compare a message included in the chatroom to a script that is primary content and may select a message containing at least a predetermined number of significant words among words absent in the primary content, as the main message 801.

As another example, the processor 220 may select the main messages 801 using the number of concurrent participants, the number of messages, stay time, or a keyword included in a message. For example, the processor 220 may determine, as the main message 801, a message corresponding to a point in time at which a large number of users are instantaneously connected in the same time zone, a point in time at which the number of messages rapidly increases in the same time zone, or a point in time at which the average stay time for each user is long.

As another example, the processor 220 may select the main message 801 using a keyword included in a conversation message. For example, the processor 220 may classify, as the main messages 801, a messages including a keyword that is directly set by an Openchat I administrator or a keyword that matches a category of Openchat I.

Depending on example embodiments, the processor 220 may track view time of users participating in the Openchat I chatroom 500 and may classify a message in an area with a view greater by at least a certain ratio than the average as the main message 801.

Referring to FIG. 9, the processor 220 may create the main messages 801 selected in the Openchat I chatroom 500 as content 910 in the form of image or video. For example, the processor 220 may create an area including the main messages 801 in the Openchat I chatroom 500 as secondary content 910 of Openchat I by converting the area to content through a screen capturing or screen recording method.

Therefore, the processor 220 may select the main messages 801 from among the messages in the Openchat I chatroom 500 and may create the secondary content 910 of Openchat I.

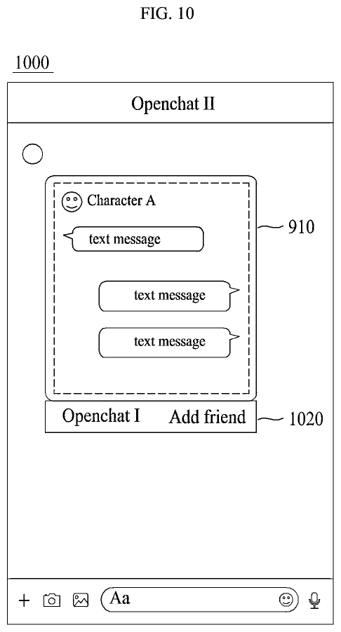

FIG. 10 illustrates an example of describing a process of sharing secondary content of openchat according to at least one example embodiment. FIG. 10 illustrates an Openchat II chatroom 1000 in which a relationship with the Openchat I is established.

An openchat administrator may set a subscription to another openchat having a similar topic or interest in relation to the openchat of the openchat administrator. For example, the administrator of the Openchat II chatroom may input a permission to subscribe to other open chats in openchat chatroom settings. According to such settings, Openchat I having a similar topic or included in the same category as the Openchat II chatroom may be selected by the computer device 200 or another computer device electrically connected to the computer device 200. The processor 220 may provide the secondary content 910 of Openchat I to which subscription is set in Openchat II through the Openchat II chatroom 1000.

As another example, the administrator of the Openchat II chatroom may input a topic of interest in openchat chatroom settings. According to such settings, Openchat I related to the topic of interest input by the computer device 200 or another computer device electrically connected to the computer device 200 may be selected. The processor 220 may provide the secondary content 910 of Openchat I to which subscription is set in Openchat II through the Openchat II chatroom 1000. As another example, the openchat II administrator may set subscription to Openchat I in Openchat II. Here, the processor 220 may provide the secondary content 910 of Openchat I to which subscription is set in Openchat II through the Openchat II chatroom 1000.

Here, the secondary content 910 of Openchat I may be displayed in the form of a conversation message of the Openchat II administrator or a content bot (e.g., dedicated bot for providing another secondary content of openchat) participating in Openchat II and openchat information 1020 that is a content source may also be provided. The openchat information 1020 may include link information to link to a page with a cover concept that is linked to Openchat I, which is a content source, to encourage subscription to openchat.

The user participating in Openchat II may share the secondary content 910 of Openchat I through the openchat II chatroom 1000 and may identify that the corresponding content is content of Openchat I through the openchat information 1020.

According to example embodiments, it may be possible to quickly create a role-playing bot on a social platform using an AI model and to use a role-playing bot for various purposes, such as determining role-playing fitness, creating a role-playing situation, and creating secondary content, on the social platform, which would be particular applications of the disclosure.

The apparatuses described above may be implemented using hardware components, software components, and/or combination of the hardware components and the software components. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, a computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to some example embodiments may be configured in a form of program instructions performed through various computer methods and recorded in non-transitory computer-readable media. Here, the media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store program instructions, such as ROM, RAM, flash memory, and the like. Examples of other media may include recording media and storage media managed by an app store that distributes applications or a site, a server, and the like that supplies and distributes other various types of software.

The foregoing embodiments are merely examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A bot-based role-playing method performed by a computer device comprising at least one processor configured to execute computer-readable instructions in a memory, the bot-based role-playing method comprising:
receiving, by the at least one processor, a script for an openchat; and
creating, by the at least one processor, at least one character bot for role-playing in the openchat by learning at least one character included in the script through an artificial intelligence (AI) language model.

2. The bot-based role-playing method of claim 1, wherein the creating, by the at least one processor, the at least one character bot for role-playing in the openchat comprises learning the at least one character, based on a line, an interaction, and situation information in the script.

3. The bot-based role-playing method of claim 1, wherein the creating, by the at least one processor, the at least one character bot for role-playing in the openchat comprises learning the at least one character by applying at least one of profile information of the at least one character and era or region information that serves as a background of the script.

4. The bot-based role-playing method of claim 1, further comprising providing, by the at least one processor, a role-playing game in which a user participating in the openchat takes on a role of the at least one character bot through the openchat.

5. The bot-based role-playing method of claim 1, further comprising pushing, by the at least one processor, a role-playing situation linked to external information based on a learned situation of a corresponding character bot through the at least one character bot that participates in a conversation within the openchat.

6. The bot-based role-playing method of claim 1, further comprising determining, by the at least one processor, role-playing fitness of a user based on the at least one character bot for the user that takes on a role of the at least one character bot.

7. The bot-based role-playing method of claim 6, wherein the determining, by the at least one processor, the role-playing fitness of the user comprises determining the role-playing fitness of the user based on answer similarity that compares the user's answer and the at least one character bot's answer for a given situation.

8. The bot-based role-playing method of claim 6, wherein the determining, by the at least one processor, the role-playing fitness of the user comprises determining the role-playing fitness of the user based on at least one of evaluation results by a role-playing master set to the openchat, a matching status with information applied during learning of the at least one character bot, and results of voting by other users that participate in the openchat, for a conversation message input from the user.

9. The bot-based role-playing method of claim 1, further comprising creating, by the at least one processor, secondary content of the openchat based on a role-laying conversation included in the openchat.

10. The bot-based role-playing method of claim 9, wherein the creating, by the at least one processor, the secondary content comprises:
selecting a main message from among conversation messages included in the openchat based on the script, and
creating the main message as the secondary content.

11. A non-transitory computer-readable recording medium storing instructions that, when executed by the at least one processor, cause the at least one processor to perform the bot-based role-playing method of claim 1.

12. A computer device comprising:
at least one processor configured to execute non-transitory computer-readable instructions included in a memory,
wherein the at least one processor is configured to process an operation of creating at least one character bot for role-playing in an openchat by learning at least one character included in a script through an artificial intelligence (AI) language model.

13. The computer device of claim 12, wherein the at least one processor is further configured to learn the at least one character, based on a line, an interaction, and situation information in the script.

14. The computer device of claim 12, wherein the at least one processor is further configured to learn the at least one character by applying at least one of profile information of the at least one character and era or region information that serves as a background of the script.

15. The computer device of claim 12, wherein the at least one processor is further configured to provide a role-playing game in which a user participating in the openchat takes on a role of the at least one character bot through the openchat.

16. The computer device of claim 12, wherein the at least one processor is further configured to push a role-playing situation linked to external information based on a learned situation of a corresponding character bot through the at least one character bot that participates in a conversation within the openchat.

17. The computer device of claim 12, wherein the at least one processor is further configured to determine role-playing fitness of a user based on the at least one character bot for the user that takes on a role of the at least one character bot.

18. The computer device of claim 17, wherein the at least one processor is further configured to determine the role-playing fitness of the user based on answer similarity that compares the user's answer and the at least one character bot's answer for a given situation.

19. The computer device of claim 17, wherein the at least one processor is further configured to determine the role-playing fitness of the user based on at least one of evaluation results by a role-playing master set to the openchat, a matching status with information applied during learning of the at least one character bot, and results of voting by other users that participate in the openchat, for a conversation message input from the user.

20. The computer device of claim 12. wherein the at least one processor is further configured to create secondary content of the openchat based on a role-laying conversation included in the openchat.
